(19) United States
(12) Patent Application Publication
(10) Pub. No.: US 2007/0070919 A1
(43) Pub. Date: Mar. 29, 2007

(54) Device and method for network configuration and computer product

(75) Inventors: Toshiki Tanaka, Kawasaki (JP); Hideyuki Miyata, Kawasaki (JP); Kouichirou Amemiya, Kawasaki (JP); Tsunehisa Doi, Kawasaki (JP); Takao Naito, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/352,868

(22) Filed: Feb. 13, 2006

(30) Foreign Application Priority Data
Sep. 28, 2005 (JP) 2005-282563

(51) Int. Cl. G06F 15/177; G06F 15/173; H04J 1/16; H04L 12/28

(52) U.S. Cl. 370/254; 370/252; 709/220; 709/223

(57) ABSTRACT

In a network, a controller controls a physical-interconnection selection switch and middle switches so as to dynamically change a network topology according to the state of the network. A traffic analyzer detects how the traffic in the network changes. If there is a change in traffic, the controller controls the physical-interconnection selection switch and the middle switches so as to change the network topology to one suitable for the changed traffic.

### BACKGROUND OF THE INVENTION

1. Field of the Invention

The present invention relates to a device and method for network configuration and a computer product for allowing easy and low-cost operation control of a network system.

2. Description of the Related Art

In conventional network systems, network configuration can be changed by manually reconfiguring physical interconnection according to a request for changing a network. However, manually reconfiguring the physical interconnection is extremely complicated, and requires a large number of working processes. Therefore, a core switch with which full-mesh connection is possible is installed in the center of the network system, to centrally control the network (such as reconfiguring of a virtual local area network (VLAN)), and to construct a network system capable of dealing with a change request for a network (for example, see “Catalyst 6500 series”, Searched on Sep. 15, 2005. Internet <URL:http://www.cisco.com/japanese/warp/public/3/jp/product/hs/switches/cat6500/>).

FIG. 15 is a diagram of a conventional network configured around a core switch. In the conventional network system, information technology (IT) devices such as layer 2 switches are interconnected in a star form around the core switch. The core switch is capable of full-mesh connection by identifying destination information for each packet inside a device, and switching a path at high speed based on the destination information identified.

With such configuration, a network operation administrator can change a connection topology between the IT devices connected to the core switch simply by changing the setting of the core switch, thus, making the operation control of the network easier and reducing operation cost.

On the other hand, a physical-interconnection selection switch has been developed as a device for switching a communication path. For example, U.S. Pat. No. 6,243,510 discloses a technology in which an arbitrary signal input from the outside is sent to an input-side interface module, converted to an electrical signal, and a path for the electrical signal is switched by an electrical matrix switch, thereby achieving physical interconnection switching. Furthermore, according to a technology disclosed in Japanese Patent Application Laid-Open No. 2002-169107, a path for a signal input from an array-type optical fiber is switched by a matrix switch using mirrors made by Micro electronics machine system (MEMS) technology, thereby achieving physical interconnection switching.

The physical-interconnection selection switches have a function of switching a signal path by switching a physical interconnection, but do not have a function of switching a destination by referring to contents such as a Media Access Control (MAC) address of a signal, unlike an Ethernet (TM) switch.

The core switch capable of full-mesh connection is expensive, and in case of a high-speed network interface, a core switch having a large scale full-mesh connection becomes more expensive. Furthermore, in association with increasing transmission rate, distortion or loss of a signal in the core switch or interference between signals occurs, thereby restricting the number of ports in which full-mesh connection is possible.

In network systems in companies that employ the configuration shown in FIG. 15, communications between IT devices such as switches connected to the core switch may be changed to communications performed mainly between IT devices belonging to the same section. Consequently, the case where all the interconnections are used for performing full-mesh communication at almost the same timing reduces. Therefore, if the core switch having the function of full-mesh connection is used in the network system, its capability may be more than what is required. Thus, cost of the network system increases.

### SUMMARY OF THE INVENTION

It is an object of the present invention to at least solve the problems in the conventional technology.

According to an aspect of the present invention, a network configuration device includes a physical-interconnection switching unit that is connectable to a plurality of switches, each switch being connectable to the physical-interconnection switching unit via at least one connection interface; each connection interfaces is connected to at least one other connection interface, inside the physical-interconnection switching unit; and a controller that controls the physical-interconnection switching unit to change a connection between the connection interfaces, to thereby change a network topology configured by the switches.

According to another aspect of the present invention, a method for network configuration includes controlling a physical-interconnection switching unit by changing a connection between a plurality of connection interfaces, thereby changing a network topology configured by a plurality of switches, wherein the physical-interconnection switching unit is connectable to the switches, each switch being connectable to the physical-interconnection switching unit via at least one connection interface.

According to still another aspect of the present invention, a computer-readable recording medium that stores thereon a computer program including instructions which, when executed, cause a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a first diagram for explaining a configuration of a network system and a change in a network topology according to an embodiment of the present invention;

FIG. 1B is a second diagram for explaining a configuration of a network system and a change in a network topology;

FIG. 1C is a third diagram for explaining a configuration of a network system and a change in a network topology;

FIG. 2 is a functional block diagram of a controller according to the embodiment;

FIG. 3A is a diagram of an example of how a traffic analyzer is connected;

FIG. 3B is a diagram of another example of how the traffic analyzer is connected;

FIG. 4A is a diagram of a specific example of how to insert a branching unit for traffic monitor between IT devices with bidirectional connection;

FIG. 4B is a first diagram of an example of how to insert the branching unit when an optical switch is used as a physical-interconnection selection switch;

FIG. 4C is a second diagram of another example of how to insert the branching unit when the optical switch is used as the physical-interconnection selection switch;

FIG. 5 is a flowchart of a process procedure for a topology changing process executed by the controller;

FIG. 6A is a diagram of an example of monitoring by the traffic analyzer and a power monitor;

FIG. 6B is a diagram of an example of monitoring by the traffic analyzer and a bitrate monitor;

FIG. 6C is a diagram of an example of monitoring by the traffic analyzer and a protocol monitor;

FIG. 7A is a diagram of how the power monitor is connected to a control port of the physical-interconnection selection switch;

FIG. 7B is a diagram of how the bitrate monitor is connected to the control port of the physical-interconnection selection switch;

FIG. 7C is a diagram of how the protocol monitor is connected to the control port of the physical-interconnection selection switch;

FIG. 8 is a diagram of an example of changing the topology when the number of outputs in some of middle switches is reduced;

FIG. 9 is a diagram of how two middle switches with a large transmission capacity are arranged at the end of a tree;

FIG. 10 is a diagram of how a redundant path is set at the end of the tree;

FIG. 11A is a diagram of an example when a plurality of networks are attached to each middle switch;

FIG. 11B is a diagram of an example when an L3 function is added only to some of the middle switches;

FIG. 11C is a diagram of an example when a representative switch is provided;

FIG. 12A is a diagram of an example when there are a plurality of types of bit rates or protocols in connection interfaces of middle switches;

FIG. 12B is a diagram of an example when a bitrate or a protocol conversion function is added only to some of the middle switches;

FIG. 12C is a diagram of an example when an I/F converter is provided;

FIG. 13 is a flowchart of a process procedure for a topology changing process based on time;

FIG. 14 is a functional block diagram of a computer for executing a network-configuration changing program according to the embodiment; and

FIG. 15 is a diagram of a conventional network configured around a core switch.

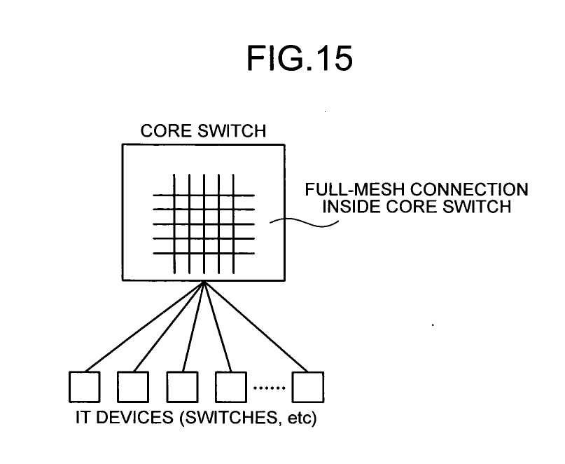

### DETAILED DESCRIPTION OF THE PREFERRED EMBODIMENTS

Exemplary embodiments of the present invention are explained in detail below with reference to the accompanying drawings.

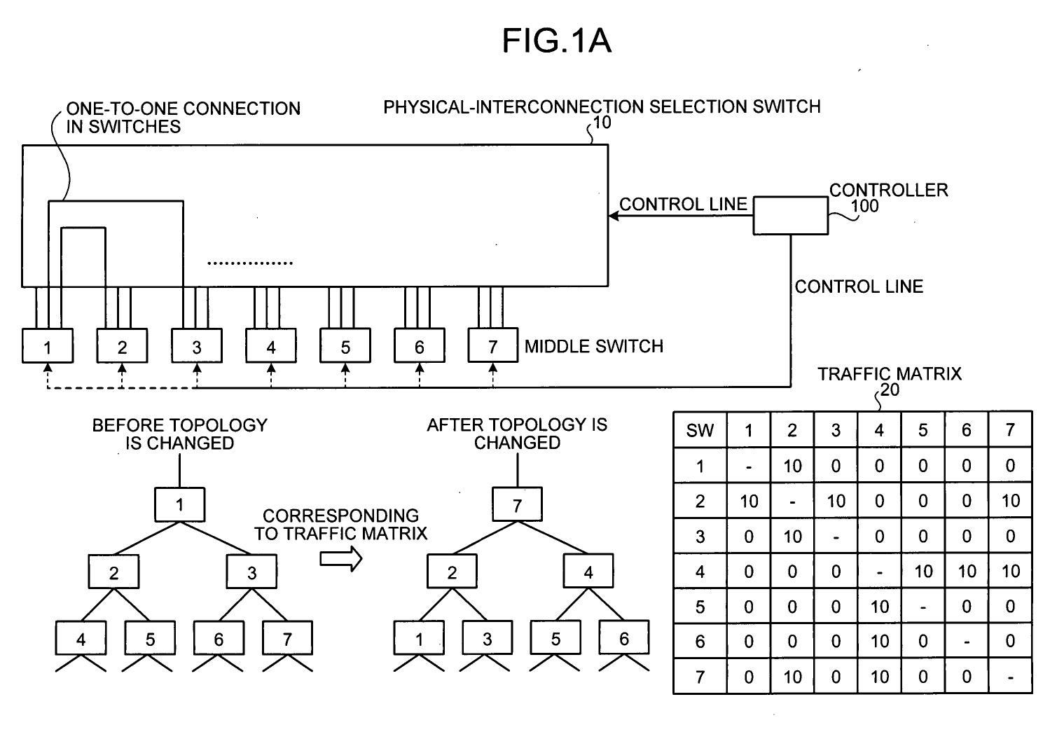

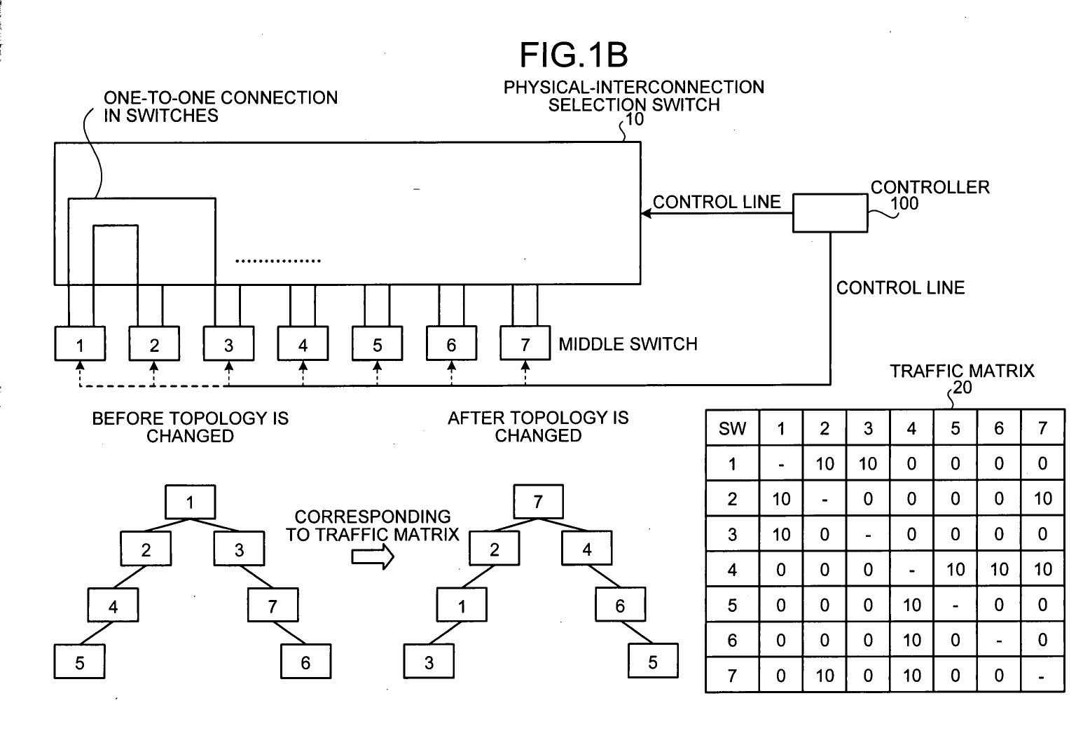

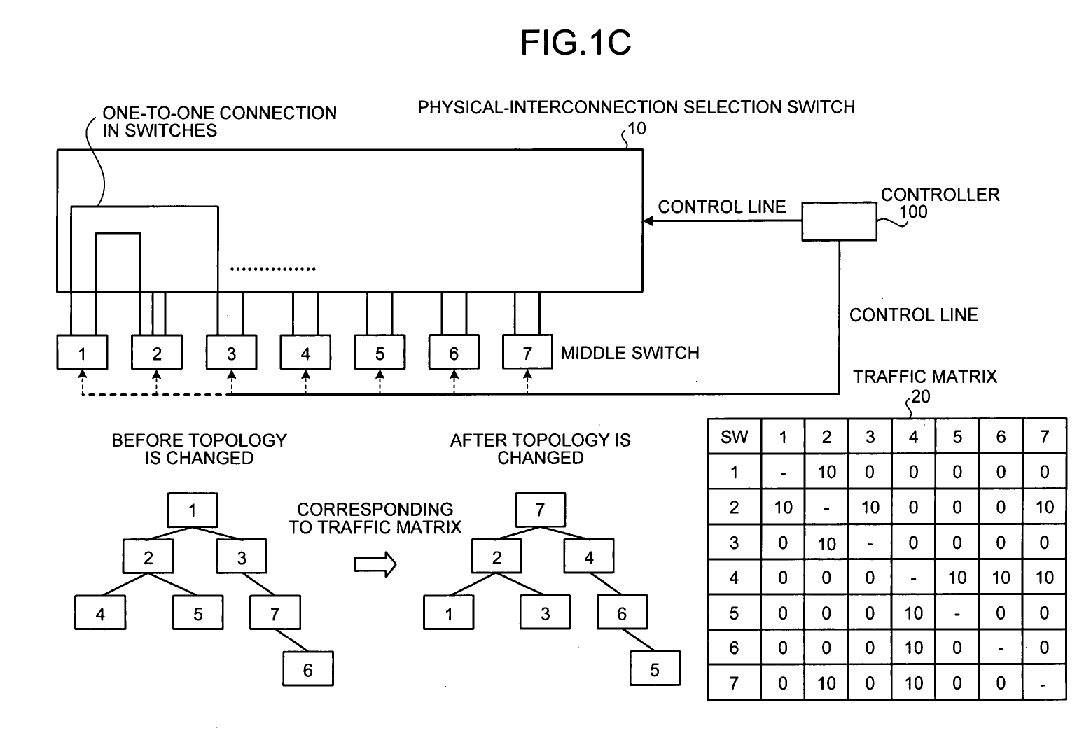

A configuration of a network system and change in a network topology according to one embodiment of the present invention are explained first with reference to FIG. 1A to FIG. 1C. FIG. 1A is a first diagram for explaining the configuration of the network system and the change in the network topology according to one embodiment of the present invention.

As shown in FIG. 1A, the network system includes a physical-interconnection selection switch 10 having slower switching speed and lower cost as compared with those of a core switch; middle switches 1 to 7; and a controller 100. For convenience of explanation, seven units of middle switches are shown in FIG. 1A, but the network system can be configured with an arbitrary number of middle switches. Furthermore, the physical-interconnection selection switch 10 may be an electrical switch or an optical switch.

The physical-interconnection selection switch 10 and each of the middle switches are connected to each other by three connection interfaces, and the controller 100 controls internal connection of the physical-interconnection selection switch 10 and setting of the middle switches 1 to 7, to thereby change the topology of the network.

More specifically, the controller 100 instructs the physical-interconnection selection switch 10 to internally connect the connection interfaces of different middle switches in one-to-one correspondence with each other, and instructs the middle switches 1 to 7 to change the settings, which enables networks of various topologies to be constructed.

One example of changing a topology is shown in FIG. 1A. The topology is such that a middle switch 1 is set as the root of a tree structure, middle switches 2 and 3 are connected to the root, middle switches 4 and 5 are connected to the middle switch 2, and middle switches 6 and 7 are connected to the middle switch 3. This topology is changed to another topology such that the middle switch 7 is set as the root of a tree structure, the middle switches 2 and 4 are connected to the root, the middle switches 1 and 3 are connected to the middle switch 2, and the middle switches 5 and 6 are connected to the middle switch 4.

The controller 100 changes the topology based on a traffic matrix 20 indicating amounts of communication between the middle switches. In this example, the controller 100 connects middle switches of which the amount of communication is not “0”, to reduce the throughput of the middle switches, thus changing the topology to a topology with high communication efficiency. For example, the middle switch 4 and the middle switch 6, which have a large communication capacity, are directly connected to each other to reduce the load on other switches. The controller 100 changes the connection of the physical-interconnection selection switch 10 via a control line and changes the setting for connecting the middle switches.

In the embodiment, the physical-interconnection selection switch 10, the middle switches 1 to 7, and the controller 100 are used to configure the network in the above manner, and the controller 100 changes the internal connection of the physical-interconnection selection switch 10 and each of the setting of the middle switches 1 to 7 based on the traffic matrix 20. It is thereby possible to reduce the network construction cost, and to dynamically change the network topology based on the amount of communication.

Particularly, if an optical switch is used as the physical-interconnection selection switch 10 and light is used as a high-speed connection interface, the number of conversion interfaces between electrical and optical signals can be reduced, thus reducing the construction cost. Furthermore, even if the transmission rate increases, the scale of the matrix switch can be increased, thus increasing scalability and flexibility of the system.

Although-the case where the topology is changed based on the traffic matrix 20 is explained here, the topology can be changed based on time or an instruction from a user. Furthermore, the topology can be changed upon addition or deletion of devices or in the event of a failure.

Furthermore, although the case where the physical-interconnection selection switch 10 and each middle switch are connected by three connection interfaces is shown in FIG. 1A, the number of connection interfaces can be set to an arbitrary value depending on the characteristics of the network system.

For example, as shown in FIG. 1B, the physical-interconnection selection switch 10 and each middle switch are connected by two connection interfaces, to configure a bus-type network as the whole network system. In this manner, the number of connection interfaces is reduced from three lines to two lines, thereby constructing a low-cost network.

Moreover, as shown in FIG. 1C, only the physical-interconnection selection switch 10 and the middle switch 2 are connected by three connection interfaces, and the physical-interconnection selection switch 10 and each of the other middle switches are connected by two connection interfaces, thereby configuring a network with a combined use of the bus type and the tree type. The connection interfaces of some of the middle switches are reduced to two lines in this manner, to enable cost reduction while ensuring the flexibility of the topology.

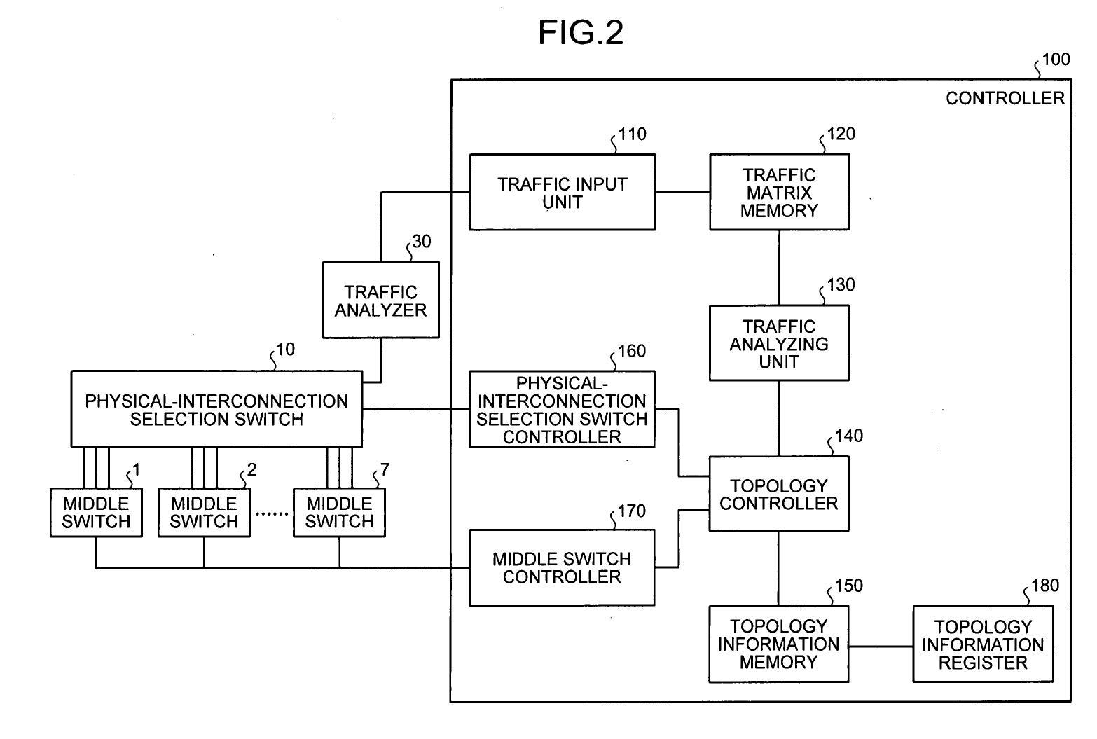

The configuration of the controller 100 according to the embodiment is explained below. FIG. 2 is a functional block diagram of the controller 100 according to the embodiment. The controller 100 includes a traffic input unit 110, a traffic matrix memory 120, a traffic analyzing unit 130, a topology controller 140, a topology information memory 150, a physical-interconnection selection switch controller 160, a middle switch controller 170, and a topology information register 180.

The traffic input unit 110 inputs traffic (amounts of communication) between middle switches. More specifically, the traffic input unit 110 periodically inputs the traffic matrix 20 from a traffic analyzer 30, and stores it in the traffic matrix memory 120.

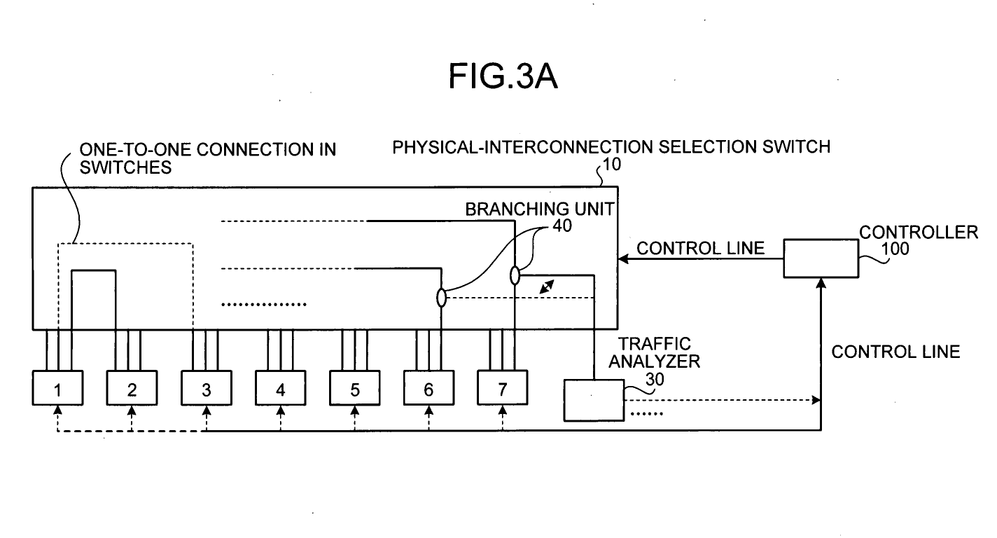

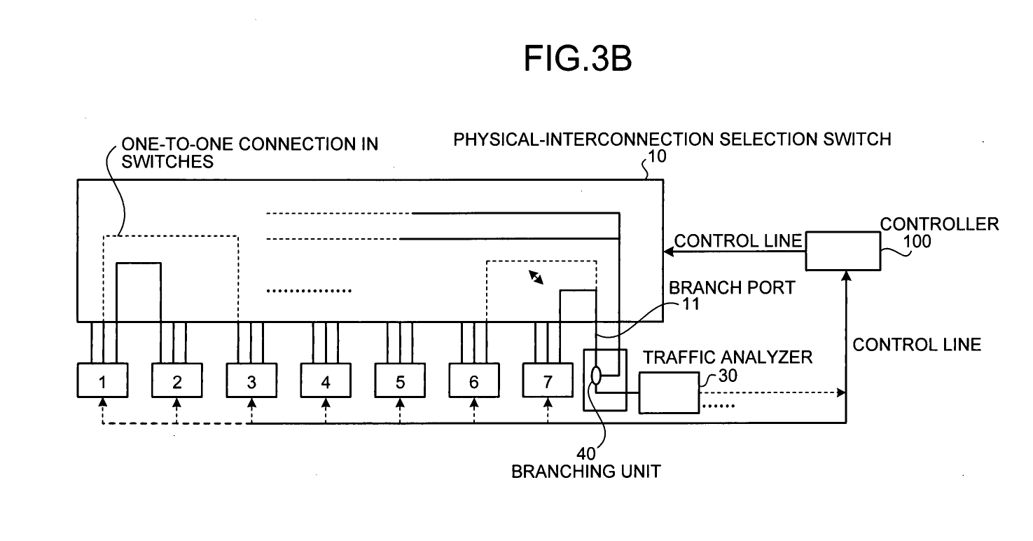

FIG. 3A is a diagram of an example of how a traffic analyzer is connected. The traffic analyzer 30 is connected to the physical-interconnection selection switch 10, and internal signals of the physical-interconnection selection switch 10 are branched by using respective branching units 40, thereby creating a traffic matrix. For example, an output signal of the middle switch 7 is branched by the branching unit 40, the signal branched is input to the traffic analyzer 30, and output signals to be branched are sequentially changed. These processes are periodically performed, thereby sampling a traffic state and measuring the traffic.

FIG. 3B is a diagram of another example of how the traffic analyzer is connected. The branching unit 40 connected with the traffic analyzer 30 is connected to a branch port 11 of the physical-interconnection selection switch 10, and the branch port 11 is connected sequentially to each port connected with each middle switch. These processes are periodically performed, thereby sampling a traffic state and measuring the traffic.

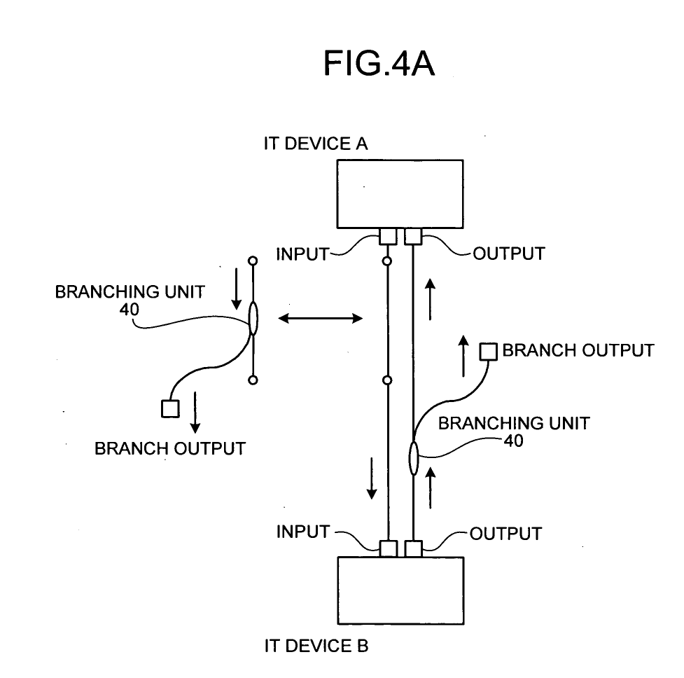

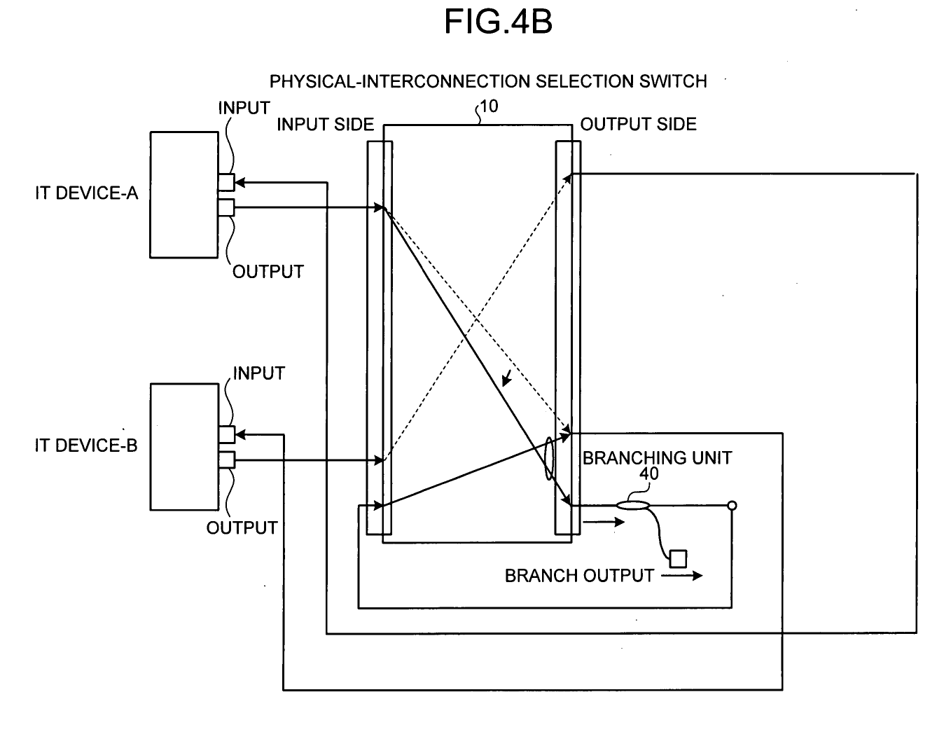

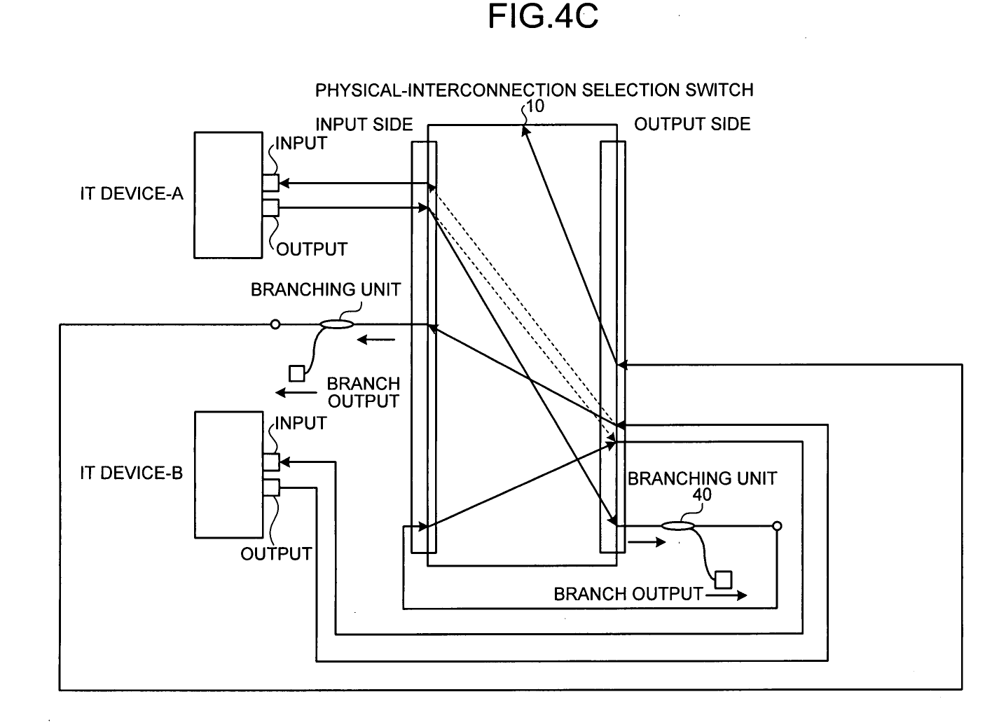

FIG. 4A is a diagram of a specific example when the branching unit 40 for traffic monitoring is inserted between IT devices A and B which are bidirectionally connected to each other. More specifically, the branching unit 40 is connected to an output side of the respective IT devices A and B, and causes a communication signal to branch to the traffic analyzer 30.

Particularly, if an optical switch is used as the physical-interconnection selection switch 10, branching of an optical signal is easier than that of an electrical signal, thus easily responding to an increase in the number of ports and an increase in the transmission rate. Furthermore, by using the optical switch, distortion or loss of waveform when a signal passing through the physical-interconnection selection switch 10 is branched can be reduced more than in the case of an electrical signal. Therefore, the traffic can be analyzed without adversely affecting the communication.

FIG. 4B and FIG. 4C are diagrams of examples of how to insert the branching unit 40 when an optical switch is used as the physical-interconnection selection switch 10. FIG. 4B indicates how to insert the branching unit 40 when all the devices can mutually be connected to each other. As shown in FIG. 4B, when all the devices can mutually be connected to each other, at least one branching unit 40 is shared by all the devices, and is polled to be connected to the branch port 11, thereby periodically acquiring traffic data.

FIG. 4C indicates how to insert the branching unit 40 when some of the devices can be mutually connected to each other, but some of the devices are inhibited from mutually connecting to each other. As shown in FIG. 4C, when some of the devices are inhibited from mutually connecting to each other, at least two branching units 40 are shared by devices in respective groups, and are polled to be connected to the branch ports 11 of the respective groups, thereby periodically acquiring traffic data.

Referring back to FIG. 2, the traffic matrix memory 120 stores the traffic matrix 20. The traffic matrix memory 120 stores the traffic matrix 20 input from the traffic analyzer 30 in association with data amounts for the last two times. The storage of the traffic matrix 20 for the last two times in the traffic matrix memory 120 allows the traffic analyzing unit 130 to detect how the traffic changes.

The traffic analyzing unit 130 detects how the traffic changes, based on the traffic matrix 20 for the last two times stored in the traffic matrix memory 120, and if the change is detected, extracts the characteristic of the traffic after the change.

For example, the traffic analyzing unit 130 can detect the following cases as those in which the traffic has changed. That is, one case is where the traffic between some middle switches changes from a value below a predetermined threshold to a value greater than the threshold, and the other case is where the traffic between some middle switches changes from a value greater than the predetermined threshold to a value below the threshold. Alternatively, the traffic analyzing unit 130 can also detect a case where the traffic between some middle switches changes more than the predetermined threshold, as a case where the traffic has changed.

Furthermore, the traffic analyzing unit 130 can extract a combination of middle switches of which traffic is more than the predetermined threshold, as the characteristic of the traffic after the change.

The topology controller 140 reads out from the topology information memory 150, information on the topology corresponding to the characteristic of the traffic extracted, and issues an instruction to the physical-interconnection selection switch controller 160 and the middle switch controller 170 to change the topology, based on the topology information read-out.

The topology information memory 150 stores information on the topology in correlation with the characteristic of the traffic. More specifically, the topology information memory 150 stores topology information with the highest communication efficiency as the characteristic of the traffic.

The topology information memory 150 stores the topology information with the highest communication efficiency as the characteristic of the traffic, and the topology controller 140 reads out the topology information corresponding to the characteristic of the traffic extracted by the traffic analyzing unit 130, and outputs an instruction to change the topology to the physical-interconnection selection switch controller 160 and the middle switch controller 170, thereby dynamically configuring a network suitable to the communication state.

The physical-interconnection selection switch controller 160 outputs the instruction to change internal connection to the physical-interconnection selection switch 10 based on the instruction of the topology controller 140. The middle switch controller 170 outputs an instruction to change the setting to the middle switches 1 to 7 based on the instruction of the topology controller 140.

The topology information register 180 registers topology in the topology information memory 150 in correlation with the characteristic of the traffic between middle switches.

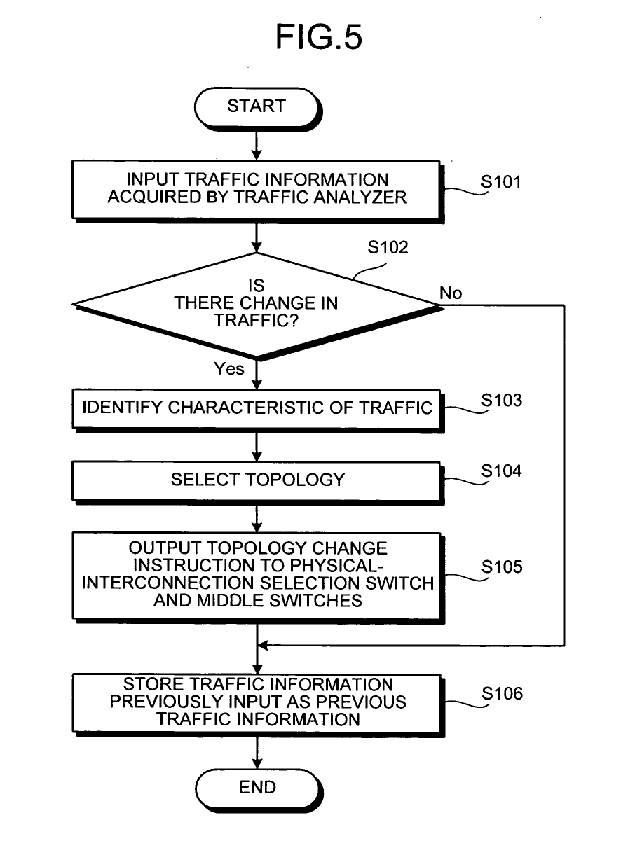

FIG. 5 is a flowchart of a process procedure for a topology changing process executed by the controller 100 according to the embodiment. Note that the topology changing process is started in a predetermined period.

As shown in FIG. 5, in the topology changing process, the traffic input unit 110 inputs the traffic information acquired by the traffic analyzer 30 (step S101), and stores the traffic information as current traffic information in the traffic matrix memory 120.

The traffic analyzing unit 130 compares the previous traffic matrix with the current traffic matrix, both of which are stored in the traffic matrix memory 120, and determines whether there is any change in the traffic (step S102). If there is no change in the traffic, the process proceeds to step S106.

On the other hand, if there is a change in the traffic, the traffic analyzing unit 130 identifies the characteristic of the traffic after the change (step S103), and transmits the characteristic to the topology controller 140. Then, the topology controller 140 selects the topology information corresponding to the characteristic of the traffic, from the topology information memory 150 (step S104).

The topology controller 140 instructs the physical-interconnection selection switch controller 160 and the middle switch controller 170 to output an instruction to change the topology to the physical-interconnection selection switch 10 and the middle switches 1 to 7 (step S105).

The traffic analyzing unit 130 stores the traffic information that is currently input by the traffic input unit 110 and stored in the traffic matrix memory 120, as the previous traffic information (step S106).

Thus, the traffic input unit 110 inputs the traffic information acquired by the traffic analyzer 30, and the traffic analyzing unit 130 compares the traffic information currently input with the traffic information previously input, to detect how the traffic changes. If there is a change in the traffic, the topology controller 140 controls the physical-interconnection selection switch 10 and the middle switches 1 to 7 to change the topology to a topology suitable for the traffic after the change, thereby flexibly dealing with the change in the traffic.

In the embodiment, the case where the topology is changed based on the traffic information acquired by the traffic analyzer 30, is explained as above. But the state of power supply in each port of the physical-interconnection selection switch 10 is monitored by the power monitor, and the topology can also be changed based on the result of monitoring the power supply in addition to the traffic information.

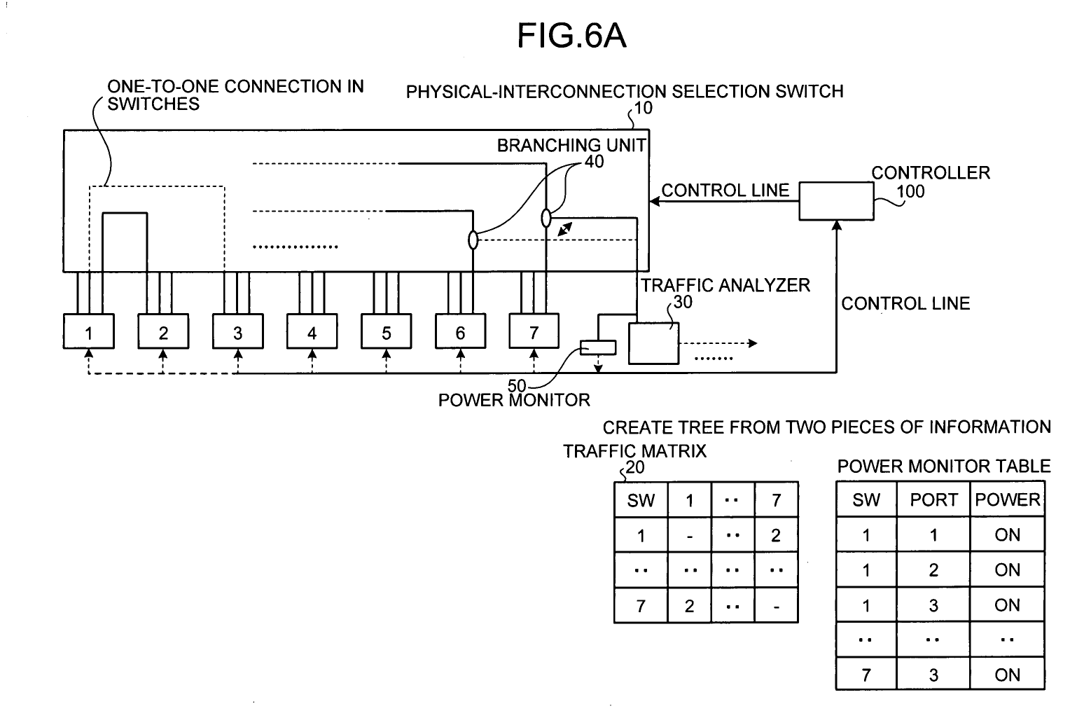

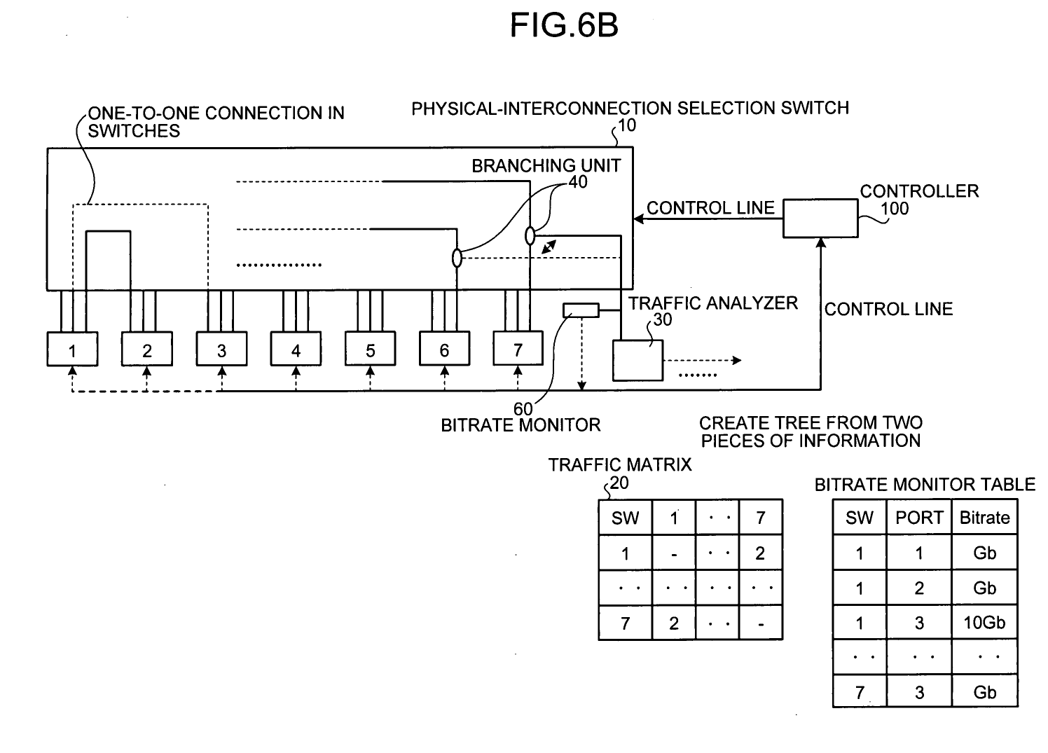

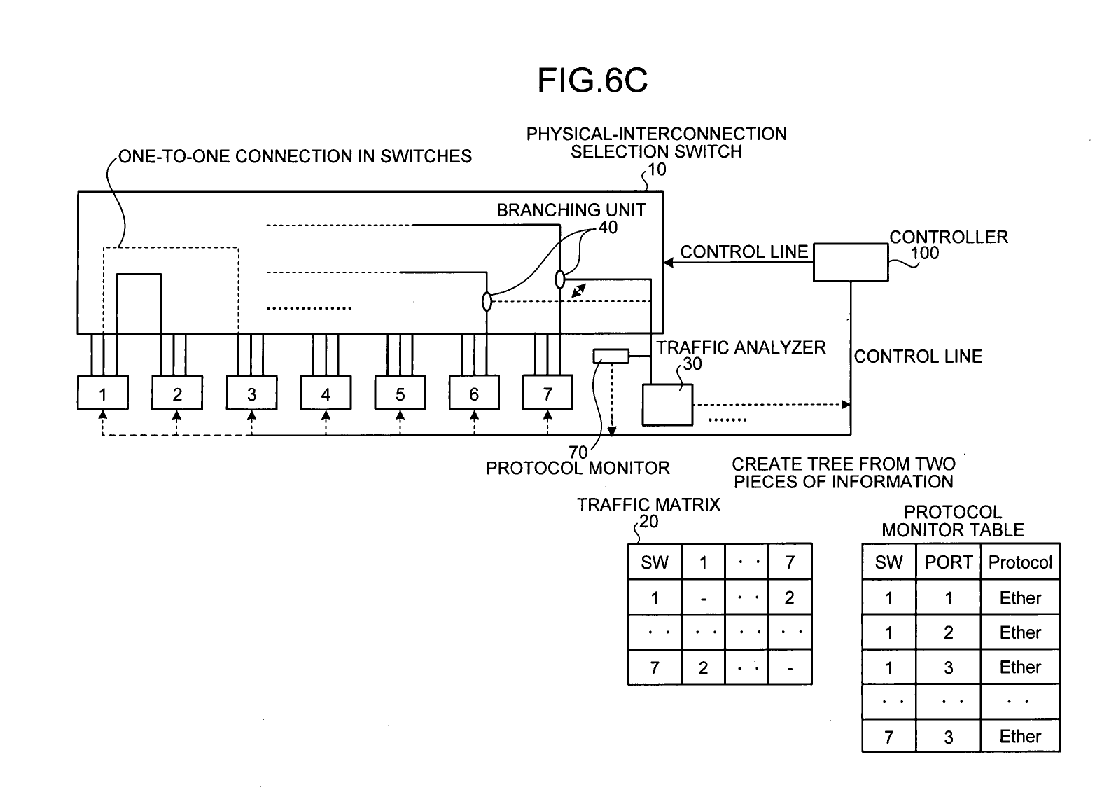

FIG. 6A is a diagram of an example of monitoring by the traffic analyzer 30 and a power monitor 50. The signal branched by the branching unit 40 is input to the traffic analyzer 30 and also to the power monitor 50, thereby enabling changing the topology based on the traffic state and the power state. A power monitor table is shown in FIG. 6A, as an example of the result of monitoring the power state.

Bit rates of the respective ports of the physical-interconnection selection switch 10 are monitored by a bitrate monitor, and the topology can also be changed based on the result of monitoring the bit rates in addition to the traffic information.

FIG. 6B is a diagram of an example of monitoring by the traffic analyzer 30 and a bitrate monitor 60. The signal branched by the branching unit 40 is input to the traffic analyzer 30 and also to the bitrate monitor 60, thereby enabling changing the topology based on the traffic state and bit rate of each port. A bitrate monitor table is shown in FIG. 6B, as an example of the result of monitoring the bit rates.

A protocol monitor monitors protocols of the respective ports of the physical-interconnection selection switch 10, and the topology can also be changed based on the result of monitoring the protocols in addition to the traffic information.

FIG. 6C is a diagram of an example of monitoring by the traffic analyzer 30 and a protocol monitor 70. The signal branched by the branching unit 40 is input to the traffic analyzer 30 and also to the protocol monitor 70, thereby enabling changing the topology based on the traffic state and protocol of each port. A protocol monitor table is shown in FIG. 6C, as an example of the result of monitoring the protocols.

The example of using the method of FIG. 3A as a method of branching an output signal is shown in FIG. 6A to FIG. 6C, but the output signal can be branched using the method of FIG. 3B. In the respective configurations of FIG. 6A to FIG. 6C, each combination of the traffic analyzer 30 with the power monitor 50, the bitrate monitor 60, or with the protocol monitor 70 is shown, but these are typical ones. Therefore, the topology can also be changed using a combination of a plurality of monitor results, with traffic information acquired by the traffic analyzer 30, of monitor results by the power monitor 50, the bitrate monitor 60, and the protocol monitor 70.

The connections of the power monitor 50, the bitrate monitor 60, or the protocol monitor 70 to the branching unit 40 are shown in FIG. 6A to FIG. 6C, but each of them can also be connected to a control port of the physical-interconnection selection switch 10.

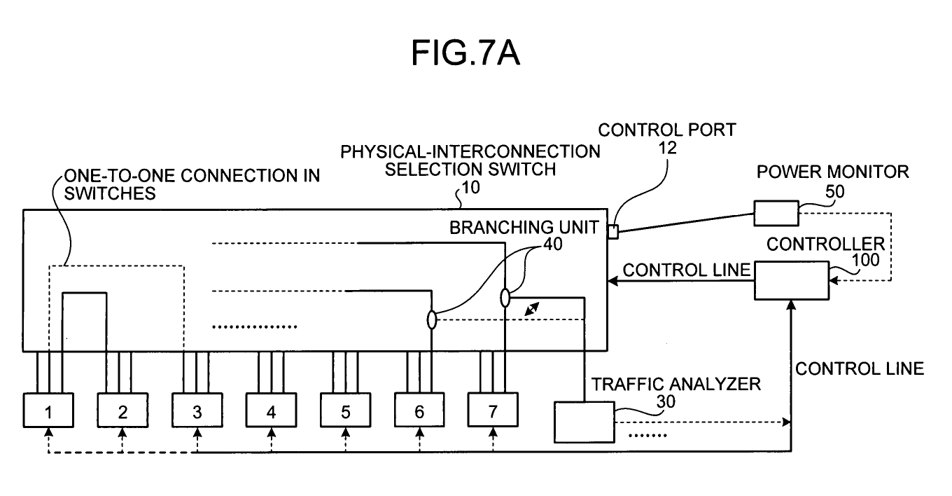

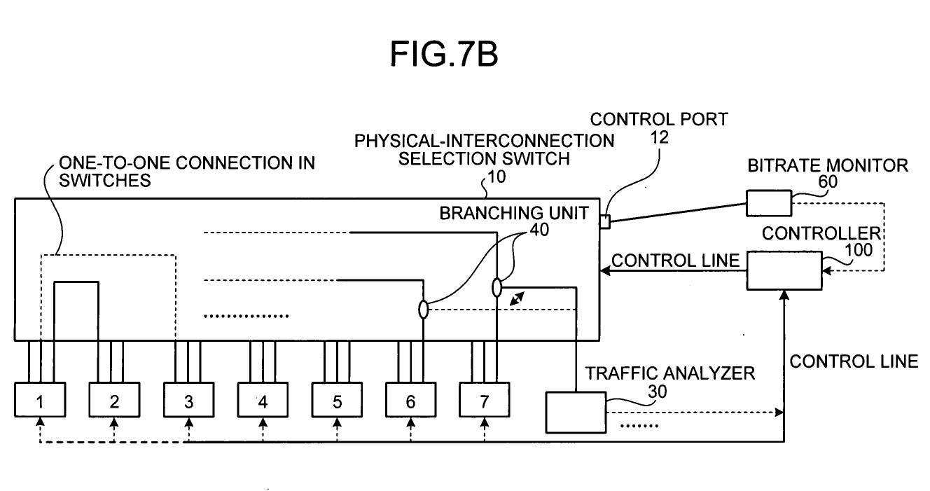

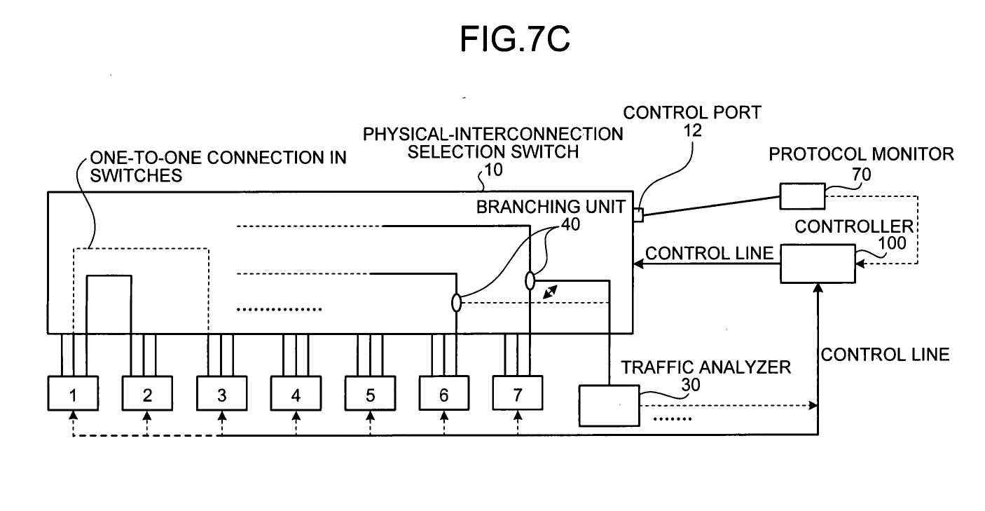

FIG. 7A is a diagram of how the power monitor 50 is connected to a control port 12 of the physical-interconnection selection switch 10. FIG. 7B is a diagram of how the bitrate monitor 60 is connected to the control port 12. FIG. 7C is a diagram of how the protocol monitor 70 is connected to the control port 12.

The combinations of the traffic analyzer 30 with the power monitor 50, the bitrate monitor 60, or with the protocol monitor 70 are shown in the configurations of FIG. 7A to FIG. 7C, but these are typical ones. Therefore, the topology can also be changed using a combination of a plurality of monitor results, with traffic information acquired by the traffic analyzer 30, of monitor results by the power monitor 50, the bitrate monitor 60, and the protocol monitor 70.

The case where all the middle switches 1 to 7 have three outputs is explained in the embodiment, but when the middle switches 1 to 7 are arranged in the tree structure, a middle switch in the lowest layer needs only one output. Therefore, some of the middle switches are always arranged in the lowest layer, thereby enabling reduction in the number of outputs of the middle switches.

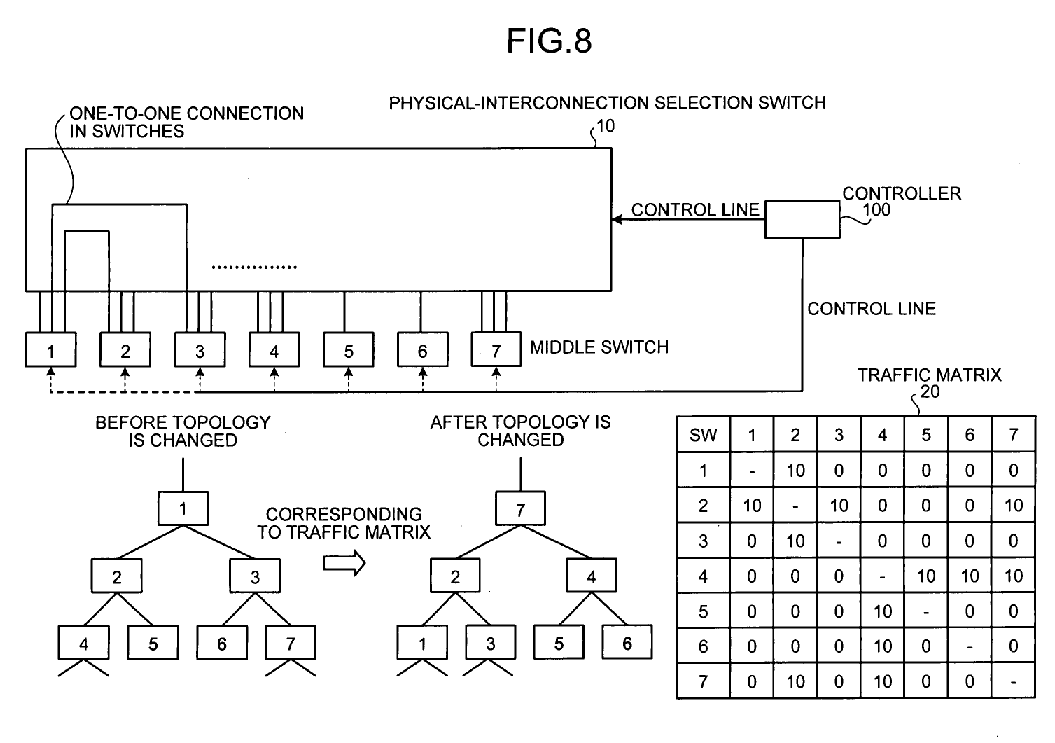

FIG. 8 is a diagram of an example of changing the topology when the number of outputs in some of the middle switches is reduced. As shown in FIG. 8, the middle switches 5 and 6 are always arranged in the lowest layer, thereby reducing number of outputs of the middle switches 5 and 6 from three to one, and this further reduces the cost of the network system. However, this reduction may affect the flexibility of changing the topology.

Because the middle switches 5 and 6 are always arranged in the lowest layer, only the topology such that the middle switches 5 and 6 are arranged in the lowest layer is registered in the topology information memory 150.

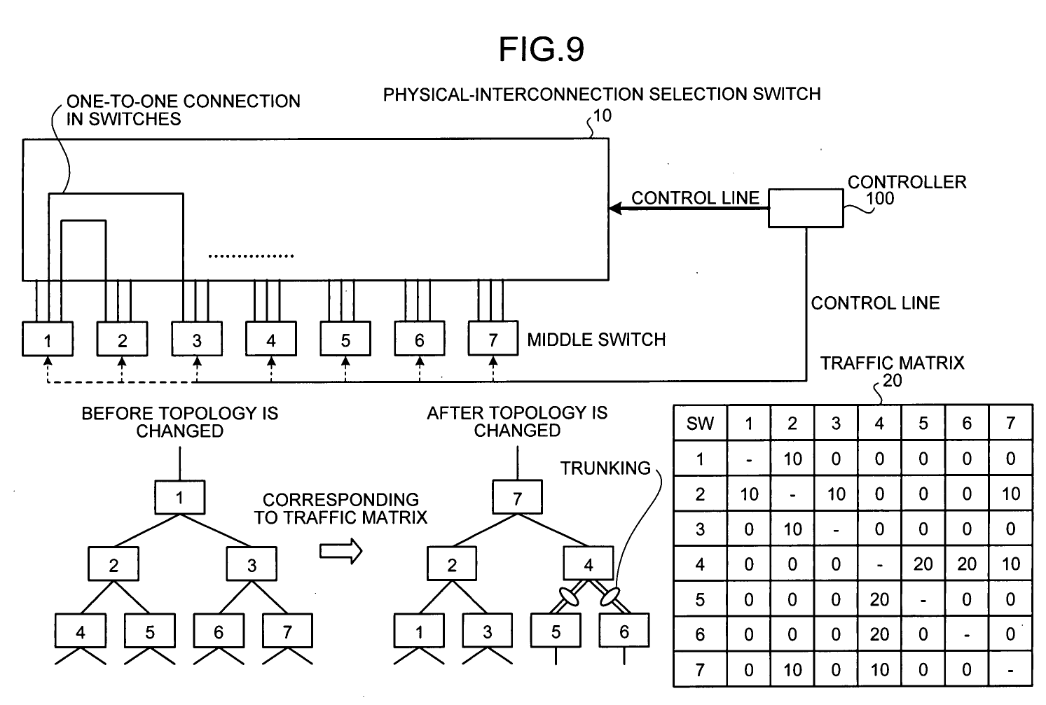

Furthermore, instead of reducing the number of outputs of the middle switches arranged in the lowest layer, an extra output can also be used to increase the transmission capacity. FIG. 9 is a diagram of how two middle switches with a large transmission capacity are arranged at the end of the tree. As shown in FIG. 9, the middle switches 5 and 6 with a large transmission capacity are arranged in the lowest layer of the tree structure, and the number of connections between the middle switch 4 and the middle switch 5, and between the middle switch 4 and the middle switch 6 are set to a plurality of lines to obtain a trunking connection. Doing so enables handling communications between middle switches with a large transmission capacity.

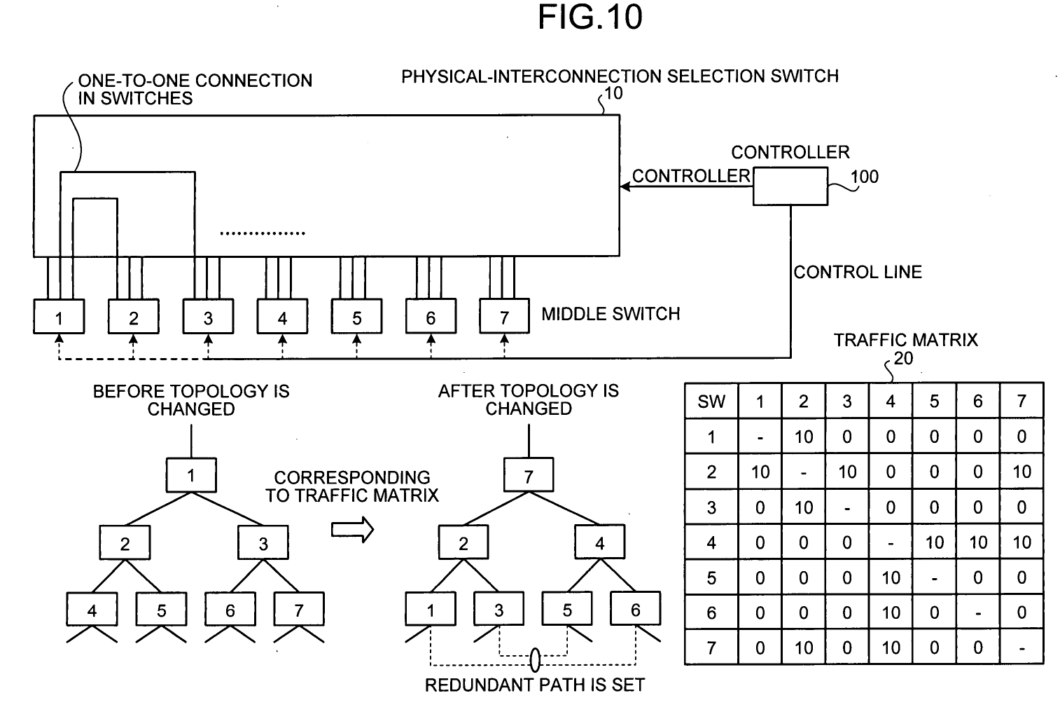

Instead of reducing the number of outputs of the middle switches arranged in the lowest layer, an extra output can also be used to improve reliability. FIG. 10 is a diagram of an example of how a redundant path is set at the end of the tree. As shown in FIG. 10, an extra output is used to set a redundant path between the middle switch 3 and the middle switch 5, and between the middle switch 1 and the middle switch 6, thereby improving reliability of the network.

The case where one network is attached to all of the, middle switches is explained in the embodiment, but a plurality of networks may be attached to the middle switches. The case where a plurality of networks may be attached to various middle switches is explained below.

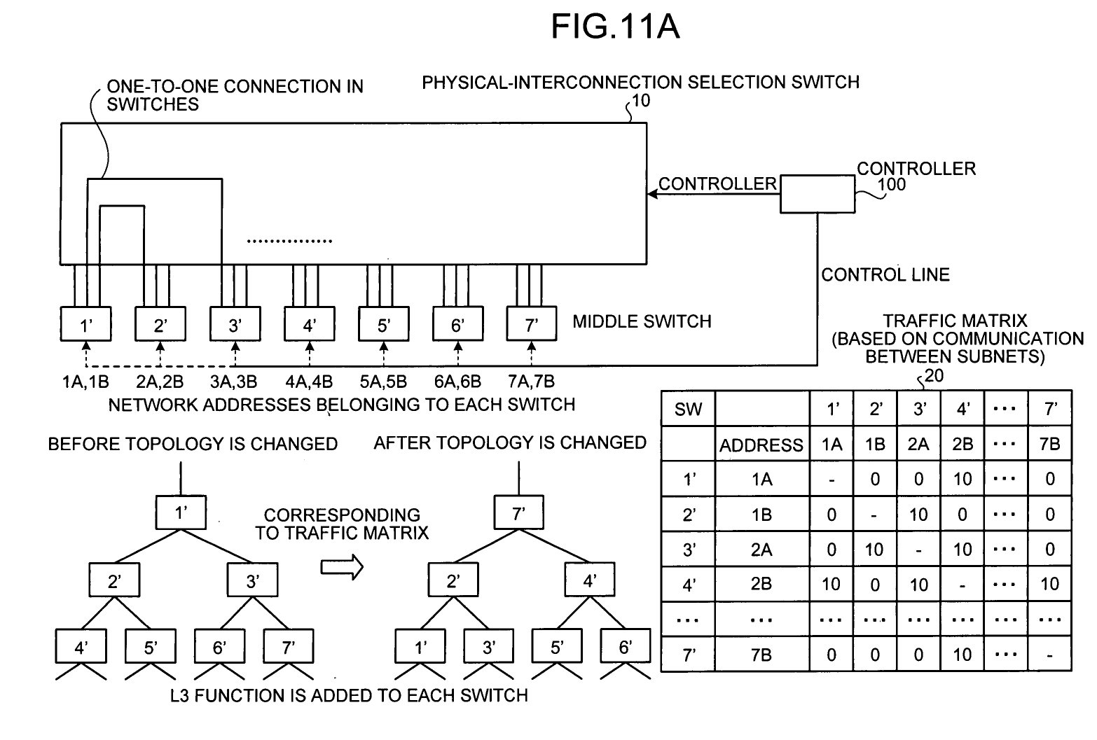

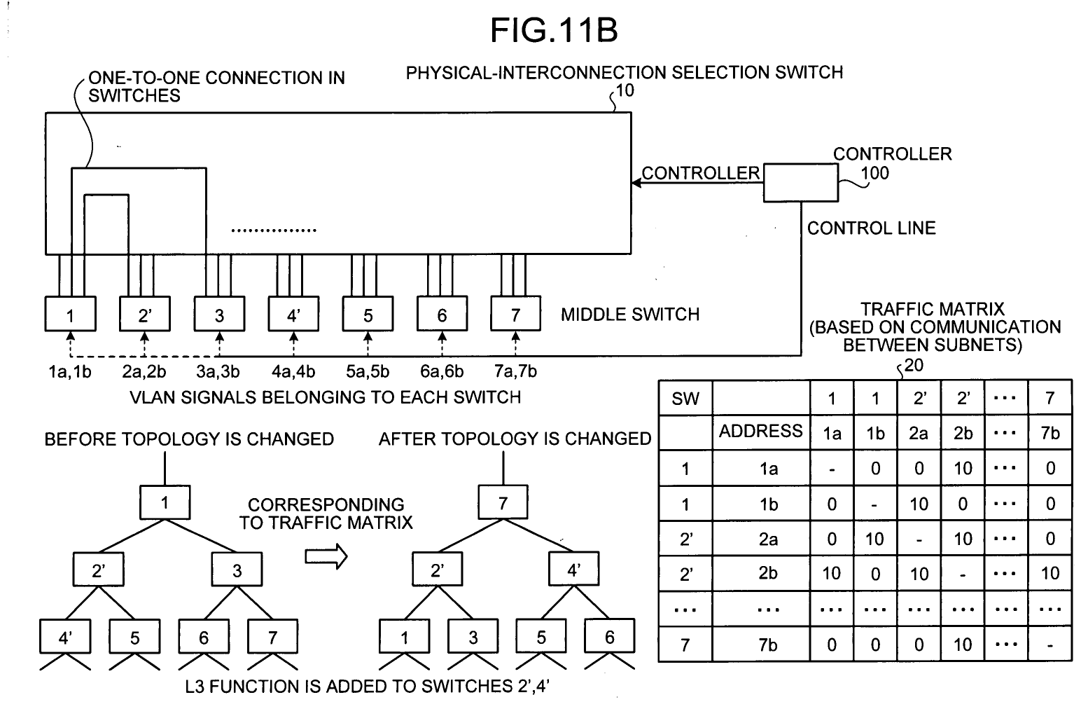

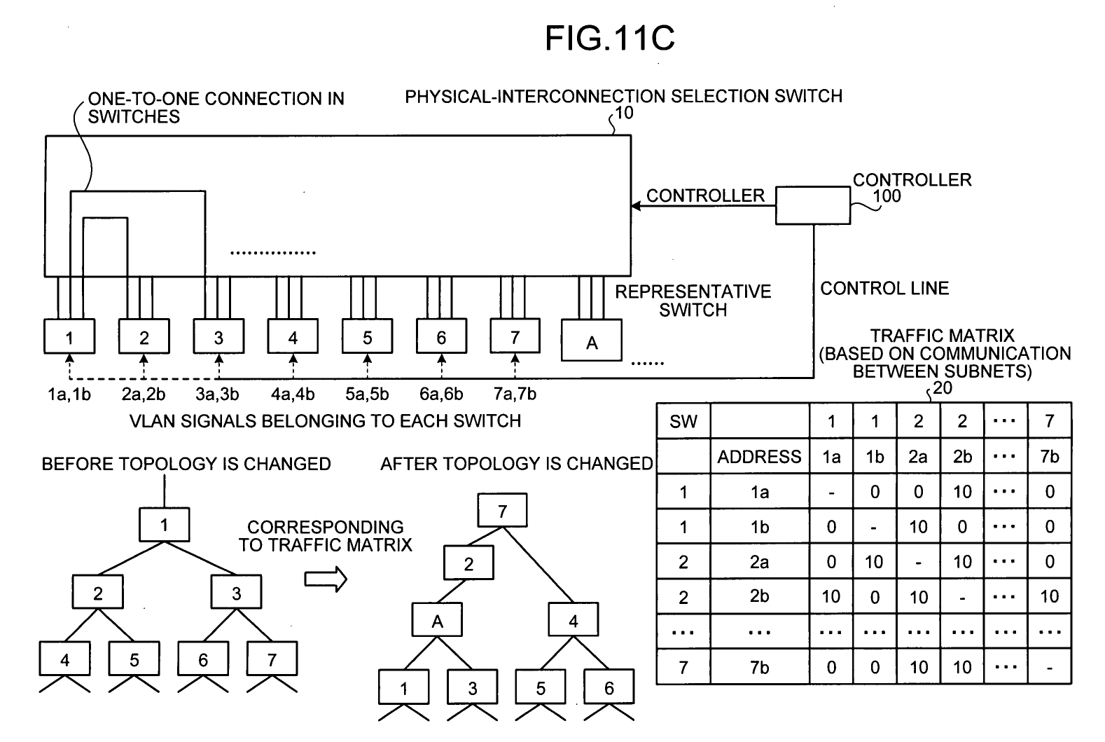

FIG. 11A is a diagram of an example when a plurality of networks are attached to each of the middle switches. In this case, a plurality of network addresses (1A, 1B to 7A, 7B) belonging to each of the respective middle switches are distributed to the middle switches. A Layer 3 (L3) function is added to each of the middle switches, thereby implementing communications between subnets. In FIG. 11A, the L3 function is added to all of middle switches 1′ to 7′.

A routing table for each of the middle switches is changed according to a control signal output from the controller 100 for each change in the topology. However, the traffic matrix 20 is assumed to provide a communication capacity not between middle switches, but between subnets in each middle switch. The controller 100 and each middle switch are directly connected to each other by the control line to provide a control signal to the middle switches, but the controller 100 and each middle switch are connected to each other through the physical-interconnection selection switch 10, to provide a control signal to the middle switches.

Instead of adding the L3 function allowing communication between subnets to all the middle switches, the L3 function can be added only to some of the middle switches. FIG. 11B is a diagram of an example when the L3 function is added only to some of the middle switches.

In this case also, a traffic matrix 20 capable of obtaining a communication state between subnets is used. In the case of communication between the same subnets, each middle switch performs communication if necessary, but in the case of communication between different subnets, each signal (VLAN signals 1a, 1b to 7a, 7b) is transmitted up to middle switches 2′ and 4′ to which the L3 function is added, thereby achieving communications between different subnets via the middle switches.

In FIG. 11B, the middle switches 2′ and 4′ have the L3 function. The controller 100 arranges middle switches so as to efficiently perform communications between different subnets when the topology is to be changed, based on presence or absence of the L3 function in the middle switches. In other words, topologies are registered in the topology information memory 150 as follows. The topologies are such that middle switches are appropriately arranged so as to efficiently perform communications between different subnets based on whether the L3 function is provided in each of the middle switches.

Instead of adding the L3 function allowing communication between subnets to all the middle switches, another middle switch (representative switch) having the L3 function can be also connected to the physical-interconnection selection switch 10. FIG. 11C is a diagram of an example when a representative switch is provided.

In this case also, a traffic matrix 20 capable of obtaining a communication state between subnets is used. In the case of communication between the same subnets, each middle switch performs communication if necessary, but in the case of communication between different subnets, each signal (VLAN signals 1a, 1b to 7a, 7b) is transmitted up to a representative switch A, to achieve communications between different subnets via the representative switch A.

The controller 100 arranges middle switches so as to efficiently perform communications between different subnets based on the case where only the representative switch A has the L3 function, when the topology is to be changed. In other words, topologies as follows are registered in the topology information memory 150. The topologies are such that middle switches are appropriately arranged so as to efficiently perform communications between different subnets based on the case where only the representative switch A has the L3 function. Furthermore, the case of providing one representative switch A is shown here, but the number of representative switches A can be also set.

FIG. 6B and FIG. 7B indicate examples of monitoring bit rates of the ports by the bitrate monitor 60, and FIG. 6C and FIG. 7C indicate examples of monitoring-protocols of the ports by the protocol monitor 70. However, if a middle switch has a connection interface whose bit rate or protocol is different from the other ones, then a function of converting a bit rate or a protocol needs to be added to the middle switch. Therefore, how the function of converting the bit rate or the protocol is added to the middle switch is explained below.

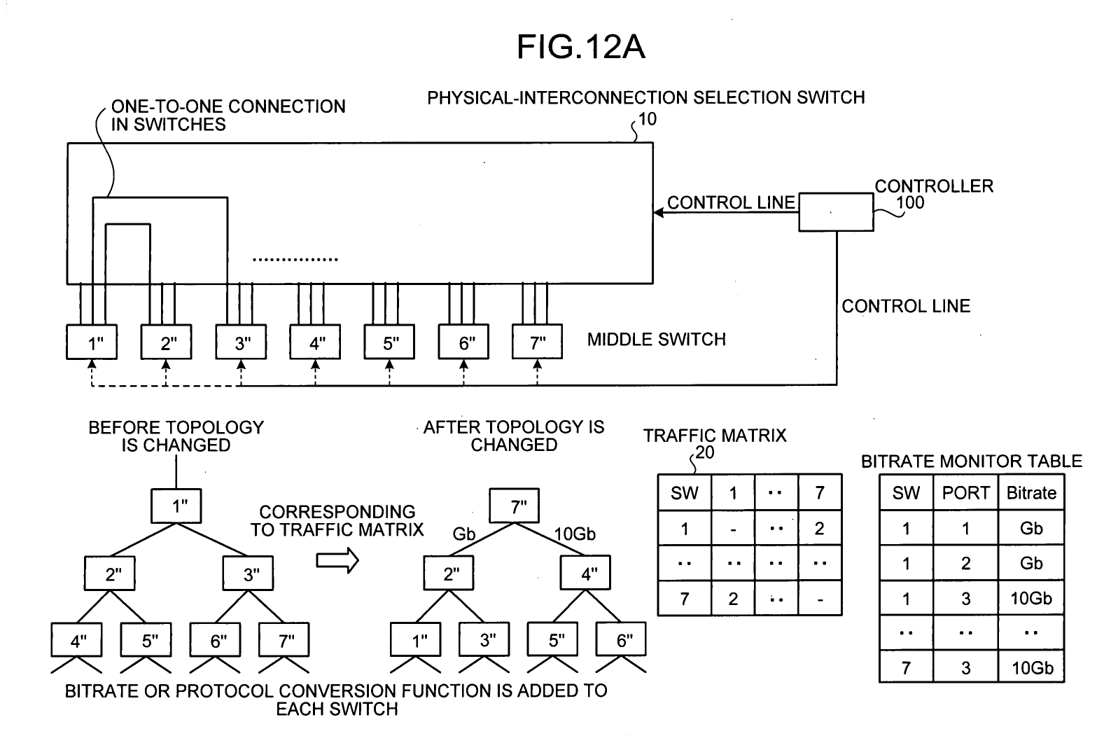

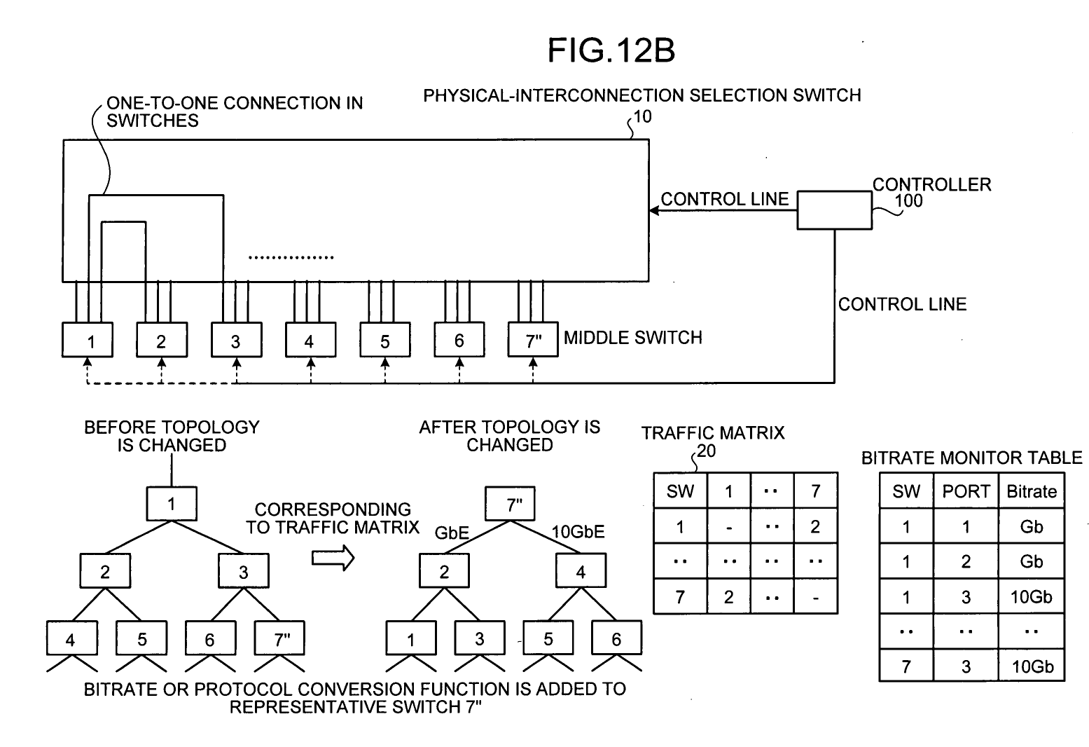

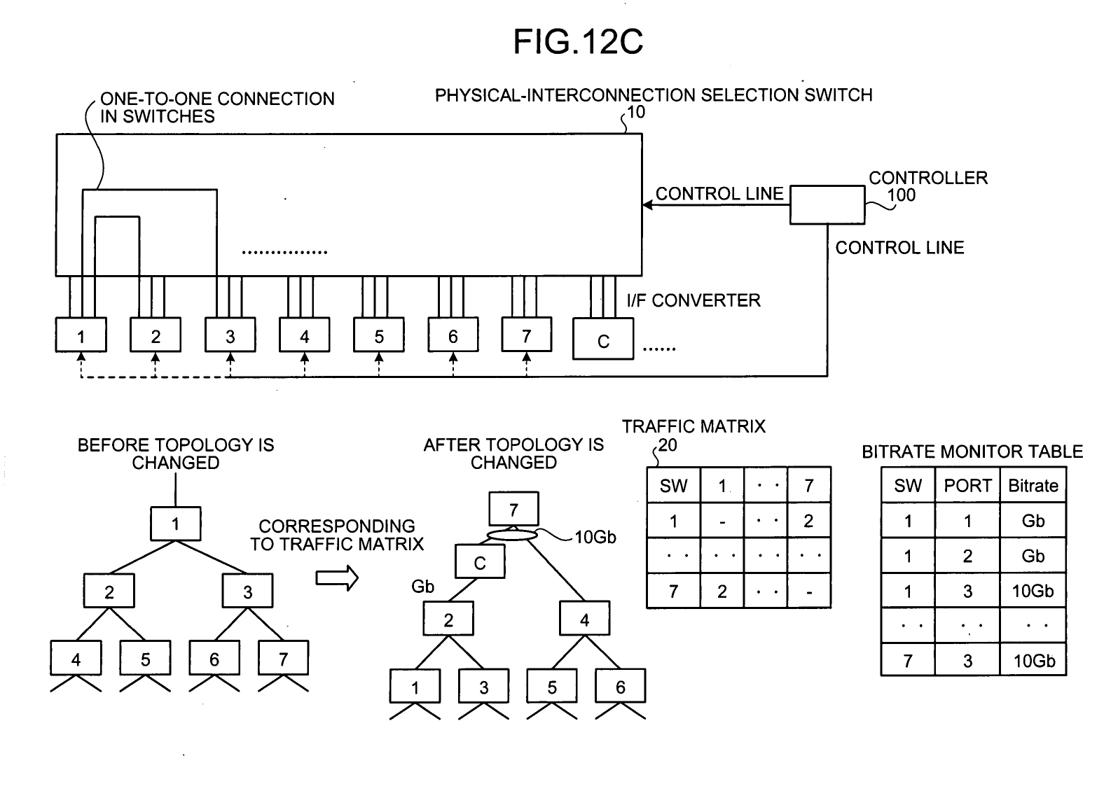

FIG. 12A is a diagram of an example when there are a plurality of types of bit rates or protocols in connection interfaces of middle switches. As shown in FIG. 12A, a bitrate or protocol conversion function is added to each middle switch, thereby constructing the network system even if there are connection interfaces with bit rates or protocols different from one another. In FIG. 12A, all of middle switches 1″ to 7″ have the bitrate or protocol conversion function.

Furthermore, instead of adding the bitrate or protocol conversion function to all the middle switches, it can also be added only to some of the middle switches. FIG. 12B is a diagram of an example when the bitrate or protocol conversion function is added only to some of the middle switches. As shown in FIG. 12B, in this example, the bitrate or protocol conversion function is added only to the middle switch 7″.

When devices having different bit rates or different protocols are to be connected to each other, the connection is performed through the middle switch 7″ having the conversion function. Thus, even if there are connection interfaces having different bit rates or different protocols, the network system can be constructed. Note that there is one middle switch having the conversion function in FIG. 12B, but a plurality of such middle switches may be provided.

The controller 100 arranges middle switches so as to efficiently perform conversion when the topology is to be changed based on presence or absence of the bitrate or protocol conversion function in the middle switches. In other words, topologies are registered in the topology information memory 150 as follows. The topologies are such that middle switches are appropriately arranged so as to efficiently perform conversion based on whether the conversion function is provided in each of the middle switches.

Instead of adding the bitrate or protocol conversion function to all the middle switches, an interface (I/F) converter having the bitrate or protocol conversion function can be connected to the physical-interconnection selection switch 10. FIG. 12C is a diagram of an example when the I/F converter is provided.

When devices having different bit rates or different protocols are to be connected to each other, the connection is performed through an I/F converter C having the conversion function. Thus, even if there are connection interfaces having different bit rates or different protocols, the network system can be constructed. Note that only one I/F converter C having the conversion function is added in FIG. 12C, but a plurality of I/F converters may be added.

When the topology is to be changed, the controller 100 arranges middle switches so as to efficiently perform conversion using the I/F converter C. In other words, topologies are registered in the topology information memory 150 as follows. The topologies are such that middle switches are appropriately arranged so as to efficiently perform conversion using the I/F converter C.

Particularly, in the configurations of FIG. 12B and FIG. 12C, by using an optical switch as the physical-interconnection selection switch 10, switching between paths can be performed independent of the bit rate and the protocol, thereby improving scalability and flexibility of the system.

The case where the controller 100 selects an appropriate topology from the topology information memory 150 to change a network topology is explained in the embodiment. But by setting a topology change time in advance, the network topology can also be changed based on the time. The process procedure for a topology changing process based on the time is explained below.

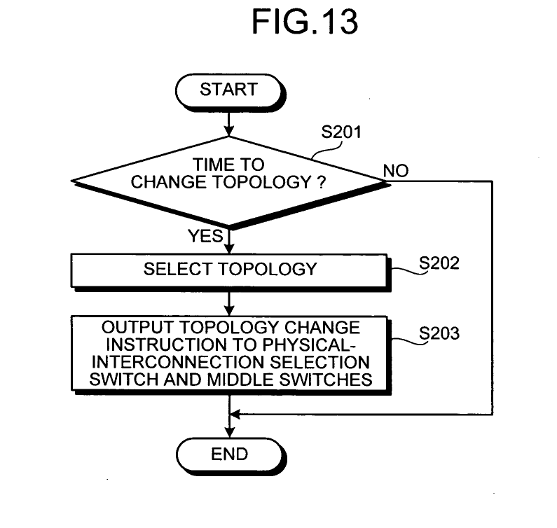

FIG. 13 is a flowchart of the process procedure for a topology changing process based on the time. The topology changing process is started at a predetermined time interval. As shown in FIG. 13, in the topology changing process, the topology controller 140 determines whether it is time to change the topology (step S201).

If it is time to change the topology, the topology controller 140 selects a topology from the topology information memory 150 (step S202), and sends a topology change instruction to the physical-interconnection selection switch 10 and the middle switches 1 to 7 (step S203). The topology information memory 150 stores information on topologies corresponding to topology change times.

The topology information memory 150 stores the information on topologies corresponding to topology change times, and when it is time to change the topology, the topology controller 140 selects a topology from the topology information memory 150 and outputs the topology change instruction to the physical-interconnection selection switch 10 and the middle switches 1 to 7. Thus, the network topology can be changed based on a schedule preset by the user.

The case where the user specifies the time to change the network topology is explained above, but the user can also specify a day of the week and a date to change the network topology. Moreover, it is possible to specify that the network topology be changed upon addition and deletion of devices or in the event of failure.

The case where the controller 100 selects a topology from the topology information memory 150 is explained here. But the present invention can also be configured so that the controller 100 accepts a specification of the topology from the user, and outputs a topology change instruction to the physical-interconnection selection switch 10 and the middle switches 1 to 7 based on the topology specified by the user.

In the embodiment as explained above, the physical-interconnection selection switch 10, the middle switches 1 to 7, and the controller 100 are used to configure the network, and the controller 100 controls the internal connection of the physical-interconnection selection switch 10 and the setting of the middle switches 1 to 7, corresponding to the change in traffic. This enables low cost construction of a network in which a topology is dynamically changed corresponding to the change in traffic or the like.

Particularly, by using an optical switch as the physical-interconnection selection switch 10, the number of conversion interfaces between electrical and optical signals can be reduced, thus further reducing the system cost. Moreover, by using an optical switch as the physical-interconnection selection switch 10, branching of a signal becomes easier. This allows the optical switch to easily support changes in bit rates and protocols, thus improving scalability and flexibility of the system and reducing the system cost required from the current state over the future.

Although the case where the middle switches are connected to the physical-interconnection selection switch is explained in the embodiment, the present invention is not limited to this case. Therefore, the present invention can also be applied to a case where any switch other than some or all of the middle switches is connected to the physical-interconnection selection switch.

Furthermore, although the case where the controller 100 controls the change of the network topology is explained in the embodiment, the configuration of the controller 100 can be realized by software, and a network-configuration changing program having the same function can be obtained. A computer for executing the network-configuration changing program is therefore explained below.

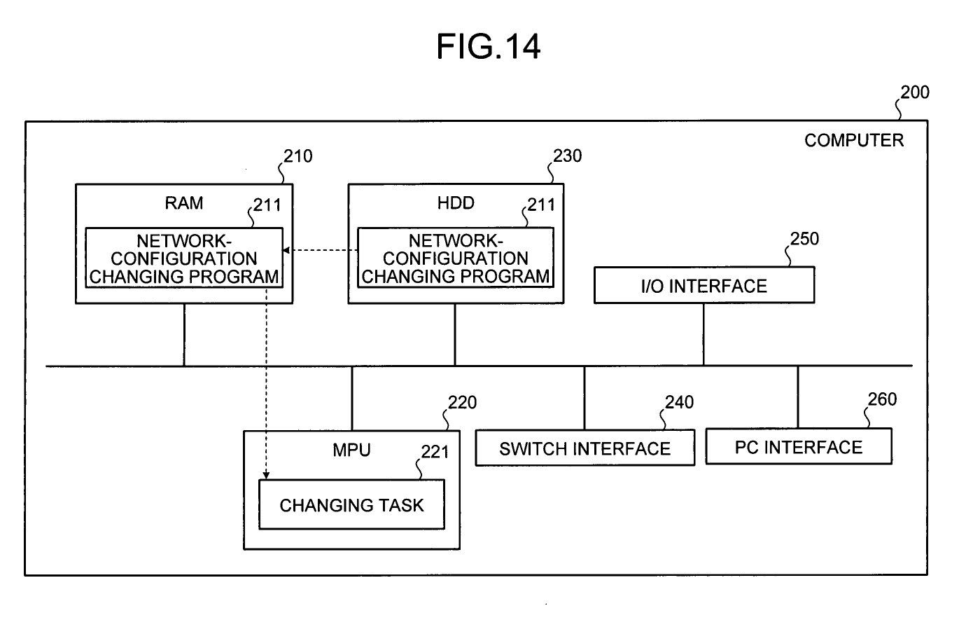

FIG. 14 is a functional block diagram of a computer for executing a network-configuration changing program according to the embodiment. As shown in FIG. 14, a computer 200 includes a Random Access Memory (RAM) 210, a Microprocessor Unit (MPU) 220, a Hard Disk Drive (HDD) 230, a switch interface 240, an input-output (I/O) interface 250, and a personal computer (PC) interface 260.

The RAM 210 stores programs and temporary results of execution of a program. The MPU 220 reads the program from the RAM 210 and executes the program. The HDD 230 stores programs and data. The switch interface 240 connects the computer 200 to the physical-interconnection selection switch 10 and the middle switches 1 to 7.

The I/O interface 250 connects an input device such as a mouse and a keyboard, and a display unit to the computer 200. The PC interface 260 connects the computer 200 to a PC.

A network-configuration changing program 211 executed in the computer 200 is downloaded from the PC via the PC interface 260 and is stored in the HDD 230.

The network-configuration changing program 211 stored in the HDD 230 is read into the RAM 210, and executed by the MPU 220 as a network-configuration changing task 221.

According to one aspect of the present invention, the construction cost of a network system reduces, and a network topology can be dynamically changed, thereby allowing easy operation control, at low cost.

Furthermore, changes in the network topology can be scheduled, thereby facilitating the operation of the network system.

Moreover, a user can easily change a network topology, thereby facilitating the operation of the network system.

Furthermore, a network topology is dynamically changed responding to the change in an amount of communication, thereby allowing easy operation control.

Moreover, a network topology is dynamically changed based on an accurately measured amount of communication, thereby enabling reliable response to the change in the amount of communication.

Furthermore, the number of the connection interfaces can be reduced, thereby reducing cost.

Moreover, the connection interfaces can be used efficiently, resulting in a remarkable cost-to-performance ratio.

Furthermore, a network topology is dynamically changed in response to the change in the amount of each communication network, thereby enabling efficient communications between the networks.

Moreover, high communication efficiency is achieved even if different bit rates or different protocols are present together.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network configuration device comprising:
a physical-interconnection switching unit that is connectable to a plurality of switches, each switch being connectable to the physical-interconnection switching unit via at least one connection interface;
each connection interfaces is connected to at least one other connection interface, inside the physical-interconnection switching unit; and
a controller that controls the physical-interconnection switching unit to change a connection between the connection interfaces, to thereby change a network topology configured by the switches.

2. The network configuration device according to claim 1, wherein
the controller executes control to change a connection between the connection interfaces based on a time condition, wherein
the time condition is any one of a user-defined time, date, and day, a preset time interval, a preset schedule, an event of adding a switch in the network, an event of removing a switch from the network, and occurrence of failure.

3. The network configuration device according to claim 1, wherein
the controller executes control to change a connection between the connection interfaces based on a user instruction.

4. The network configuration device according to claim 1, wherein
the controller executes control to change a connection between the connection interfaces based on an amount of communication between the switches.

5. The network configuration device according to claim 4, further comprising:
a traffic analyzer that measures the amount of communication between-the switches, wherein
the controller executes control to change a connection between the connection interfaces based on measured amount of communication.

6. The network configuration device according to claim 5, further comprising:
a power monitor that monitors output power of ports of the switches connected with the connection interfaces, and obtains a monitoring result, wherein
the controller executes control to change a connection between the connection interfaces based on the monitoring result.

7. The network configuration device according to claim 5, further comprising:
a bitrate monitor that monitors bit rates of the connection interfaces, and obtains a monitoring result, wherein
the controller executes control to change a connection between the connection interfaces based on the monitoring result.

8. The network configuration device according to claim 5, further comprising:
a protocol monitor that monitors protocols of the connection interfaces, and obtains a monitoring result, wherein
the controller executes control to change a connection between the connection interfaces based on the monitoring result.

9. The network configuration device according to claim 5, wherein the physical-interconnection switching unit includes a control port to which a monitoring device can be connected,
the controller executes control to change a connection between the connection interfaces based on a result of monitoring by the monitoring device connected to the control port, and
the monitoring device is any one of a power monitor, a bitrate monitor, and a protocol monitor.

10. The network configuration device according to claim 1, wherein
at least one of the switches is connected to the physical-interconnection switching unit with only one connection interface, and
when the plurality of switches are connected in a tree structure, the controller executes control to change a connection between the connection interfaces so as to arrange the switch, which is connected with the one connection interface, in a lowest layer of the tree structure.

11. The network configuration device according to claim 1, wherein
when the plurality of switches are connected in a tree structure, the controller arranges the switches, between which an amount of communication is large, in a lowest layer of the tree structure, and makes a trunking connection between the switches using a plurality of connection interfaces.

12. The network configuration device according to claim 1, wherein
when the plurality of switches are connected in a tree structure, the controller executes control to form a redundant path between the switches arranged in a lowest layer of the tree structure by connecting the connection interfaces.

13. The network configuration device according to claim 4, wherein
each switch belongs to at least two networks, and
the controller executes control to change a connection between the connection interfaces based on an amount of communication between the networks and the switches.

14. The network configuration device according to claim 13, wherein
at least one of the switches includes a Layer 3 function, and
the controller executes control to change a connection between the connection interfaces to efficiently perform communication between different networks using the switch having the Layer 3 function.

15. The network configuration device according to claim 13, wherein
a representative switch with a Layer 3 function is connected to the physical-interconnection switching unit, and
the controller executes control to change a connection between the connection interfaces to efficiently perform communication between different networks using the representative switch.

16. The network configuration device according to claim 2, wherein
at least one of the connection interfaces operates with any one of a different bit rate and a different protocol, and
the controller connects between the connection interfaces to efficiently perform any one of bit rate conversion and protocol conversion.

17. The network configuration device according to claim 16, wherein
at least one of the switches has any one of a bit rate conversion function and a protocol conversion function, and
the controller executes control to change a connection between the connection interfaces to efficiently perform any one of the bit rate conversion and the protocol conversion using the switch having any one of the bit rate conversion function and the protocol conversion function.

18. The network configuration device according to claim 16, wherein
an interface converter, having any one of a bit rate conversion function and a protocol conversion function, is connected to the physical-interconnection switching unit, and
the controller executes control to change a connection between the connection interfaces to efficiently perform any one of the bit rate conversion and the protocol conversion using the interface converter.

19. A method for network configuration, comprising:
controlling a physical-interconnection switching unit by changing a connection between a plurality of connection interfaces, thereby changing a network topology configured by a plurality of switches, wherein the physical-interconnection switching unit is connectable to the switches, each switch being connectable to the physical-interconnection switching unit via at least one connection interface.

20. A computer-readable recording medium that stores thereon a computer program including instructions which, when executed, cause a computer to execute:
controlling a physical-interconnection switching unit by changing a connection between a plurality of connection interfaces, thereby changing a network topology configured by a plurality of switches, wherein the physical-interconnection switching unit is connectable to the switches, each switch being connectable to the physical-interconnection switching unit via at least one connection interface.
